(19) United States
(12) Patent Application Publication
(10) Pub. No.: US 2026/0042125 A1
(43) Pub. Date: Feb. 12, 2026

(54) PRESSURE BLASTER FOR EFFICIENT BIOFOULING REMOVAL OF UNDERWATER STRUCTURES

(71) Applicant: Saudi Arabian Oil Company, Dhahran (SA)

(72) Inventors: Ibrahim S. Alsalamah, Thuwal (SA); Fadl Abdellatif, Thuwal (SA); Ali J. Alrasheed, Thuwal (SA); Brian Parrott, Thuwal (SA); Yousef Damanhouri, Thuwal (SA)

(73) Assignee: Saudi Arabian Oil Company, Dhahran (SA)

(21) Appl. No.: 18/795,748

(22) Filed: Aug. 6, 2024

(51) Int. Cl. B08B 9/023; B05B 1/20; B05B 13/00; E02B 17/00; G01N 29/04

(52) U.S. Cl. CPC B08B 9/023; B05B 1/20; B05B 13/005; G01N 29/04; B08B 2209/02; E02B 17/0034; G01N 2291/2634

(57) ABSTRACT

An apparatus for removing biofouling from underwater structures is disclosed. The apparatus includes a base. The base is configured to at least partially encircle an underwater structure such as a pipe. A plurality of nozzles are arranged in a circular arc around the base. Each nozzle is directed towards the underwater structure. An inlet supply is connected to the plurality of nozzles. The inlet supply provides pressurized fluid to the nozzles. A zero-thrust mechanism is included to balance forces exerted by the pressurized fluid against the underwater structure to maintain a spacing of the apparatus relative to the underwater structure within a prescribed tolerance. Also disclosed is a method for removing biofouling from underwater structures.

### FIELD OF THE DISCLOSURE

The present disclosure relates generally to the field of maintenance and inspection of submerged infrastructures, and more specifically to a pressure fluid blaster having a configuration that complements the shape of an underwater structure for efficient removal of biofouling.

### BACKGROUND OF THE DISCLOSURE

Underwater infrastructures, such as pipelines and support pillars for offshore platforms, play a role in numerous industrial applications, including energy production, desalinization, and waste disposal. Maintaining these structures necessitates regular cleaning to remove biofouling—a buildup of marine organisms—that not only impairs the function and integrity of the infrastructure but can also interfere with inspection processes. Traditional methods for biofouling removal involve manual scraping or the use of rudimentary tools, which can be time consuming, labor intensive, and potentially harmful to the underlying structures.

The challenges posed by biofouling are amplified by the limitations of existing cleaning technologies. Commonly used underwater pressure blasters are designed to target a limited surface area, necessitating multiple passes and manual adjustment to clean entire surfaces. When dealing with circular assets like pipes, operators must move the blasters in a circular path to achieve thorough cleaning, an activity that is inherently inefficient and constrained by the limited time a diver can safely remain submerged. More generally, blasters have to be maneuvered around whatever the shape of the underwater structure is in order to fully address biofouling. Moreover, the design of these blasters does not address the need for coverage and speed in the cleaning process.

Significant to the operation of underwater infrastructure is the conduction of non-destructive testing (NDT), such as ultrasonic testing (UT), for which biofouling must be cleared to allow for direct contact with the structure's surface. Current practices typically separate the cleaning process from inspection, thereby prolonging the overall maintenance duration. The separation of these processes has prompted the need for a solution that can facilitate simultaneous cleaning and inspection to optimize underwater asset management.

In light of the problems associated with existing cleaning methods, the industry is in need of tailor-made technologies. Solutions offering automation are desirable, as they have the potential to reduce human diver involvement, thus improving safety and operational timelines. Automation comes with additional benefits such as the ability to perform tasks with increased precision and consistency, leading to improved results and the potential for continuous operation, which is valuable in underwater environments where human activity is limited.

These demands present a need for an advanced cleaning apparatus specifically designed for underwater structures that addresses the inadequacies of present implementations. Such a device would ideally provide a more comprehensive cleaning area coverage, minimize the manual effort requirement, integrate inspection capabilities, and successfully operate within the challenging conditions posed by subsea environments.

### SUMMARY OF THE DISCLOSURE

In one or more embodiments, an apparatus is provided for removing biofouling from underwater structures. This apparatus includes a base that defines a predetermined shape, often circular, having a surface along its length. The surface is sized to at least partially encircle or complement an underwater structure. Arranged in a line along the arched surface of the base, a plurality of nozzles is situated and at least one nozzle amongst this plurality is directed toward the underwater structure. The apparatus further comprises an inlet supply which is in fluid communication with the plurality of nozzles and serves to provide pressurized fluid thereto. Additionally, a zero-thrust nozzle is positioned in such a way that its fluid outlet is appropriately sized. This particular sizing of the fluid outlet balances the forces exerted by the pressurized fluid that is directed toward the underwater structure by at least one of the plurality of nozzles. The purpose of this balancing is to maintain the apparatus's spacing relative to the underwater structure within a prescribed tolerance.

In more particular arrangements, the plurality of nozzles includes respective valves that are selectively operable to open and close. In some implementations, an arrangement of the nozzles forms a continuous slit along the surface of the base. In some arrangements, the apparatus further comprises a drive system and wheels connected to the base. In some variations, the drive system autonomously moves the wheels and the base around the underwater structure. In one or more implementations, the plurality of nozzles comprises at least two nozzles of different size. In some implementations, the nozzles are configured to emit a pressurized fluid at an angle relative to the base. In some arrangements, the apparatus further comprises an ultrasonic test probe positioned to scan the underwater structure.

In some variations, the base is rotatable to fully encircle or traverse the profile of an underwater structure. In one or more implementations, the base further comprises a hinge mechanism connecting a first arcuate segment of the base with a second arcuate segment of the base. In some implementations, the base further comprises a control system having a processor, a memory, and code stored in the memory and executable in the processor. Additionally, an integrated pressure regulator having an output signal is included. In some arrangements, the processor is configured by the code to modify the pressure output by the plurality of nozzles in response to the output signal from the integrated pressure regulator.

In one or more embodiments, a method of removing biofouling from underwater structures is also provided. This method includes positioning a fluid blaster having a predetermined shape in proximity to an underwater structure. Following the positioning, a plurality of nozzles on the fluid blaster are activated by an activation mechanism. Once activated, the fluid blaster emits a stream of pressurized fluid directed towards the underwater structure. The method further involves moving the fluid blaster along a dimension of the underwater structure, ensuring that all areas subject to biofouling are addressed.

In more particular arrangements, the method further comprises selectively operating individual nozzles which include respective valves. In some implementations, activating the plurality of nozzles comprises creating a continuous pressurized stream from a perforation arrangement. In some arrangements, the method further comprises automating the movement of the fluid blaster using an integrated wheeled mechanism. In one or more implementations, the integrated wheeled mechanism advances the wheels and the base around the underwater structure. In some variations, the step of advancing is performed by a drive system. In some implementations, activating the plurality of nozzles comprises maintaining uniform pressure output from at least two nozzles of different sizes. In some arrangements, the step of maintaining is facilitated by a water pressure gauge. In some variations, the method further comprises adjusting the angle of the pressurized fluid emission relative to the underwater structure. In one or more implementations, the method further comprises inspecting the structure using an integrated ultrasonic test probe.

In some implementations, the method further comprises adjusting the fluid blaster angle relative to the structure. In some arrangements, the method further comprises adjusting the pressure output for individual nozzles. In some variations, the step of adjusting the pressure output is performed with an integrated pressure regulator. In one or more implementations, the integrated pressure regulator has a control system with a processor, a memory, and code stored in the memory executable in the processor. In some implementations, the integrated pressure regulator has an output signal. In some arrangements, the processor is configured by the code to modify the pressure output by the plurality of nozzles in response to the output signal from the integrated pressure regulator.

The pressure blaster and method of use therefor can be tailored to accommodate various underwater structures beyond circular pipes, taking into account the specific geometric configurations that may be present. In some configurations, a base of the pressure blaster may have a predetermined shape having a surface therealong that complements the shape of an underwater structure. Such a configuration maximizes contact with the structure's surface, which may include complex geometries such as angled or faceted surfaces commonly associated with man-made underwater assets.

In some implementations, nozzles are arranged in a line along the surface of the base. In additional variations, at least a portion of the base comprises first and second arcuate segments, further comprising a hinge mechanism connecting the first arcuate segment of the base with the second arcuate segment of the base.

The details of one or more implementations are set forth in the accompanying drawings and the description below. Other features will be apparent from the description, from the drawings, and from the claims.

### BRIEF DESCRIPTION OF THE DRAWINGS

The foregoing and other objects and advantages of the present disclosure will become more apparent when considered in connection with the following detailed description and appended drawings in which like designations denote like elements in the various views, in which:

FIG. 1 depicts a fluid pressure blaster with a universal attachment, pressure rod, and optimized rectangular slots according to one or more embodiments.

FIG. 2 depicts a top view of a fluid pressure blaster according to one or more embodiments.

FIG. 3A depicts a wireframe view of a fluid pressure blaster according to one or more embodiments. FIG. 3B depicts a close-up wireframe view of an internal portion of a fluid pressure blaster according to one or more embodiments.

FIG. 4 depicts yet another view of a fluid pressure blaster according to one or more embodiments.

FIG. 5 depicts a universal attachment to connect a fluid pressure blaster to a pressure rod according to one or more embodiments.

FIG. 6A depicts a fully enclosed apparatus with a hinge in an open configuration according to one or more embodiments. FIG. 6B depicts a fully enclosed apparatus with a hinge in a closed configuration according to one or more embodiments.

FIG. 7 depicts a multiple nozzle with fluid outlet arrangement for the apparatus according to one or more embodiments.

FIG. 8 depicts a selectable outlet port mechanism for controlling nozzle with fluid outlet fluid pressure and placement according to one or more embodiments.

FIG. 9 depicts a wireframe view of a selectable outlet port mechanism for controlling nozzle with fluid outlet fluid pressure and placement according to one or more embodiments.

FIG. 10 depicts a three-dimensional perspective view of a fully circular design incorporating a selectable outlet port mechanism for controlling nozzle with fluid outlet fluid pressure and placement according to one or more embodiments.

FIG. 11 depicts a wireframe view of a three-dimensional perspective rendering of a fully circular design incorporating a selectable outlet port mechanism for controlling nozzle with fluid outlet fluid pressure and placement according to one or more embodiments.

FIG. 12 depicts a half-circle nozzle with fluid outlet configuration where jets are pointing in opposite directions of fluid flow for counteracting fluid flow force.

FIG. 13 depicts a full-circle nozzle with fluid outlet configuration where each nozzle with fluid outlet has an equal and opposite nozzle with fluid outlet for counteracting fluid flow force.

FIG. 14 depicts a control system 1410 acting as an internal pressure regulator for the pressure blaster 110, according to one or more embodiments.

### DETAILED DESCRIPTION OF CERTAIN EMBODIMENTS CONSISTENT WITH THE DISCLOSURE

The present disclosure relates to underwater structures, such as pipelines, which are susceptible to biofouling. Biofouling—defined as the fouling of pipes and underwater surfaces by organisms such as barnacles and algae—is a pervasive issue in underwater infrastructure inspection. Underwater infrastructure such as pipes and pillars often require sensing probes which incorporate direct coupling mechanisms. The coupling mechanisms are designed to couple the sensing probes directly to the underwater infrastructure assets. Presence of a biofouling layer prevents sufficient access to the infrastructure surface that needs to be inspected. Therefore, biofouling often must be removed before inspection can begin.

The pressure blaster disclosed herein improves biofouling removal for underwater structures with, among other shapes, a circular design that wraps around a pipe's circumference. With strategically placed nozzles with fluid outlets in a line along the arched surface, biofouling can be removed more rapidly and effectively in one pass for at least half the pipe's diameter. In some variations, the tool incorporates a design that covers half of a pipe's circumference. The tool's design allows for variation, including coverage for the whole pipe perimeter and the addition of mobility features such as wheels for automation, enhancing its adaptability and functionality in diverse underwater cleaning scenarios.

In one or more embodiments, an arcuate arrangement of the nozzles in conjunction with a continuous slit nozzle fluid outlet concept, provide for more even cleaning across an underwater asset's surface. In some variations, the present disclosure contains customizable nozzle numbers and arrangements, capable of adapting to pipes of varying sizes and shapes. Moreover, the present disclosure integrates biofouling removal with potential inspection probes, such as ultrasonic testing (UT) probes, allowing for simultaneous cleaning and inspection operations. The variation concepts, including selectable outlet ports and the addition of automation mechanisms, offer versatility and increased operational efficiency.

The present disclosure addresses the inefficiencies of traditional methods, particularly through its ability to perform complete biofouling removal with fewer passes, saving time and resources. The pressure blaster disclosed herein possesses adaptability to different pipe sizes and geometric configurations, along with the ability to integrate with automated systems. Further, the present disclosure is designed to withstand high pressures necessary for thorough cleaning by incorporating design features that offset opposing thrust forces.

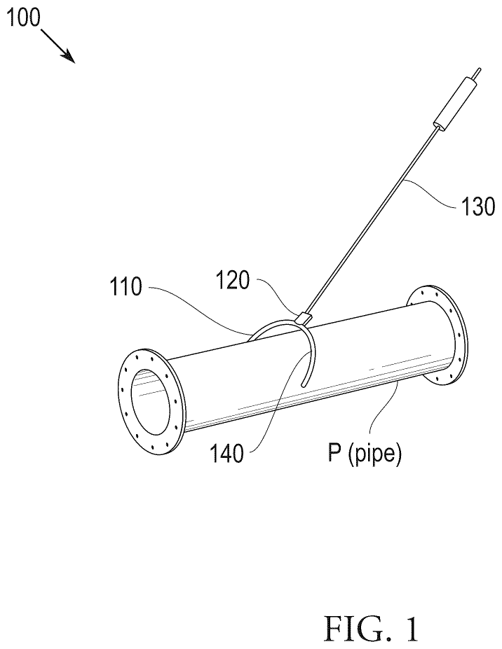

FIG. 1 depicts a fluid pressure blaster base 110 with a universal attachment 120, pressure rod 130, and optimized rectangular slots 140 according to one or more embodiments. As illustrated, the base includes an arcuate to circular exterior shape by which this combination of elements 100 facilitates the cleaning of underwater assets such as cylindrical pipes P. In one or more implementations, a cavitation blaster base 110 (also referred to herein as a pressure blaster 110, a circular fluid pressure blaster 110, and an arcuate (e.g., circular) cavitation blaster 110) base defines a circular arc having an arched surface therealong which is sized so as to fit around a portion of the circumferential profile of a cylindrical pipe P. In various implementations, the cavitation blaster 110 can be tailored for circular pipes of all sizes, regardless of whether a pipe P is installed vertically or horizontally. In various implementations, the blaster can have a different predetermined shape to complement other underwater structures, such as a base comprising straight, triangular or rectangular segments. Utilizing the cavitation blaster 110 enables removal of biofouling accumulation on the portion of the pipe that is submerged and exposed to underwater surroundings.

In one or more implementations, the combination of elements 100 for biofouling removal also contains a universal attachment 120. In various implementations, the universal attachment 120 enables cavitation blasters of various sizes and shapes to be used interchangeably to accommodate pipes P of various sizes, shapes, and dimensions. In various implementations, a pressure rod 130 is also utilized in conjunction with the universal attachment 120 and cavitation blaster 110. The pressure rod 130 is a new design element in some implementations. In other implementations, cavitation blaster 110 is fit onto existing pressure rod 130 designs, and in such implementations, universal attachment 120 ensures a proper fit for accommodating existing pressure rod 130 designs.

To achieve the goal of reducing the time to clean underwater assets by ridding them of biofouling, the present disclosure covers more area than past solutions. In one or more embodiments consistent with the present disclosure, the cavitation blaster 110 is a tube with multiple nozzles with fluid outlets arranged along an interior of the arc of the cavitation blaster 110 so as to point at an underwater asset such as a pipe P. In various implementations, the cavitation blaster 110 also contains optimized slots 140 (also referred to as nozzles with fluid outlets 140). In one or more implementations, the slots 140 are small enough to accelerate the flow and strong enough to remove the biofouling layer from the pipe.

In some implementations, the present disclosure comprises an apparatus for removing biofouling from an underwater structure with a base, wherein the base has a predetermined shape to complement the asset to be cleaned. For instance, the base can define a portion of a circular arc having an arched surface therealong which is sized so as to at least partially encircle an underwater structure such as a pipe. In one or more implementations, the present disclosure further comprises a plurality of nozzles with fluid outlets, wherein the plurality of nozzles is arranged in a line along the arched surface around the base, and wherein each nozzle with a fluid outlet is directed towards the underwater structure. In multiple implementations, the present disclosure further comprises an inlet supply, wherein the inlet supply is connected to and in communication with the plurality of nozzles with fluid outlets, and wherein the inlet supply provides pressurized fluid and to and is in communication with the nozzles. In some implementations, the present disclosure further comprises a zero-thrust nozzle with fluid outlet configuration, wherein nozzles with fluid outlets are configured to balance forces exerted by the pressurized fluid against the underwater structure to maintain a spacing of the apparatus relative to the underwater structure within a prescribed tolerance. In other words, the net flow out of the plurality of nozzles is counterbalanced by substantially the same net flow out of the zero-thrust nozzle which points in the opposite direction than the plurality of nozzles, so as to push water from the front and from the back of the apparatus at the same time. This opposing-direction nozzle with fluid outlet design balances thrust forces, creating a “zero thrust” directional output. This zero thrust output generated by opposing nozzle directions cases use of the pressure blaster, preventing divers from being pushed away from the target underwater asset by the high pressure of fluid-jet nozzles.

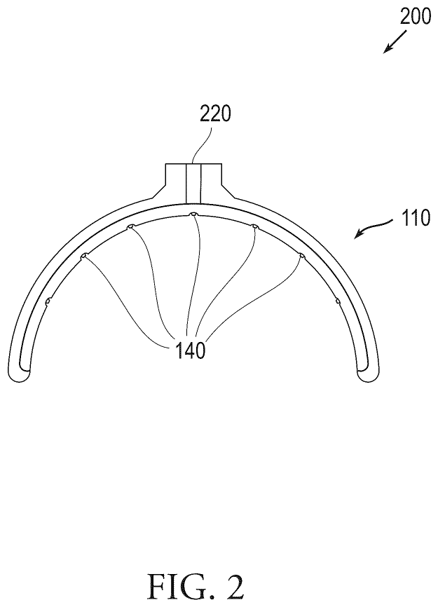

FIG. 2 depicts a top view of a fluid pressure blaster 110 according to one or more embodiments 200. In one or more implementations, the pressure blaster 110 includes slots 140. In some implementations, the slots 140 are rectangular. In further implementations, the slots 140 are circular. In one or more implementations, the slots 140 can be covered or closed to change the number of the slots available on a particular apparatus for use in a given project. More generally, the number of slots 140 or nozzles with fluid outlets 140 are variable and interchangeable based on the size of the cavitation blaster 110 or underwater asset to be cleaned. The slots 140 or nozzles with fluid outlets 140 typically correlate to jets that pump fluid out of the nozzles and towards or away from the underwater asset contaminated by biofouling. In multiple implementations, the pressure blaster 110 also incorporates a universal attachment 220. This universal attachment 220 facilitates coupling of the pressure blaster 110 with either new or preexisting pressure rod designs, such as pressure rod 130 depicted in FIG. 1.

In some implementations, the slots 140 are pointing in both the direction of the pipe P and in a direction opposite of the direction of the pipe P. Such implementations incorporate a “zero-thrust mechanism” comprising pairs of opposing nozzles with fluid outlets to achieve a surprising benefit over prior solutions. The zero-thrust mechanism improves upon a common issue where pressure rods and cavitation blasters do not remain in a consistent and steady position relative to an underwater asset to be cleaned. Without the zero-thrust mechanism, when water or other cleaning solutions are pushed through cavitation blasters, the blasters are often forced out of position due to equal and opposite forces in the water pushing the blasters away from the asset as fluid is pumped towards it.

One or more implementations incorporate respective valves for each nozzle 140 in the plurality of nozzles 140. In multiple implementations, each of the nozzles 140, strategically arranged in a line along the arched surface of the base of the pressure blaster 110, is equipped with an individually operated valve that allows for selective control of the pressurized fluid directed towards the underwater structure. These valves are designed to be selectively operable, enabling the apparatus to adapt fluid pressure and flow to the specific requirements of the biofouling removal task at hand. For instance, when the surface to be cleaned exhibits varying degrees of biofouling density or when obstacles necessitate changes in the pressure output, either a controller governed by a processor executing code that configures the controller to open or close the valves, say, using a solenoid or motor responsive to signals from the controller, or the operator himself or herself can engage or disengage valves as needed, tailoring the fluid stream for optimum cleaning efficiency. In one or more implementations, the fluid pressure blaster 110 can have an arbitrary predetermined shape, including being provided with a base having an arbitrary predetermined shape. In multiple implementations, a pressure blaster 110 consistent with the present disclosure is provided with a shape complimentary to the shape of the structure to be analyzed and targeted for biofouling removal. For instance, in certain applications the pressure blaster comprises a device having an arcuate exterior to complement the shape of a pipe or other curved structure.

In yet further implementations, the cavitation blaster incorporates a continuous slit nozzle fluid outlet concept instead of a multi-jet nozzle concept, such as the multi-jet nozzle concept depicted by nozzles with fluid outlets 140 in FIG. 2. Implementations of the present disclosure incorporating the continuous slit nozzle fluid outlet concept are capable of cleaning an entire exterior (e.g., circumference) of an underwater asset or subsection of a circumference evenly. Whether a multi-jet nozzle concept or a continuous slit nozzle fluid outlet concept is employed in various implementations, the option to incorporate a complementary shaped base (e.g., a semi-circular or fully circular pressure blaster shape) is available and consistent with the present disclosure. In some implementations, the plurality of nozzles with fluid outlets 140 are selectively operable via a valve to open and close. In some implementations, an arrangement of the nozzles forms a continuous slit along the in a line along an arched surface of the pressure blaster base.

Positioning the pressure blaster 110 is performed by a diver-operator handling an attachment rod to the pressure blaster 110, in one or more implementations. However, positioning the pressure blaster 110 is also capably performed with an underwater robot (a.k.a. an “ROV”). In some implementations, such an ROV is controlled remotely for positioning of the pressure blaster 110 relative to an underwater asset, by an operator on the surface of the boat. In various implementations, an ROV contains a vision system to locate and position the pressure blaster 110 next to the desired underwater asset to be cleaned. In one or more implementations, an ROV utilizes a proximity sensor to position the pressure blaster 110 at a specific distance from the underwater asset to be cleaned. In other implementations, an ROV contains magnetic wheels to station itself to an underwater asset to be cleaned before and during positioning of the pressure blaster 110 relative to the underwater asset to be cleaned.

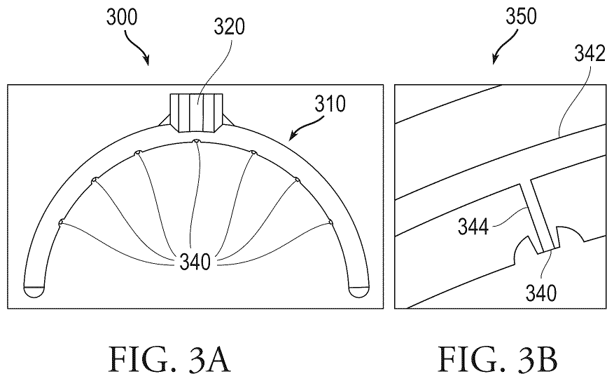

FIG. 3A depicts a wireframe view 300 of a circular fluid pressure blaster 310 according to one or more embodiments. In some implementations, the fluid pressure blaster includes nozzles with fluid outlets 340. The number of nozzles with fluid outlets 340 are variable in some implementations consistent with the present disclosure, and the nozzle with fluid outlet 340 arrangement can be varied depending on many factors. The number of nozzles with fluid outlets 340 depends on the size of the pipe being inspected and can be optimized to ensure a desired degree of coverage.

FIG. 3B depicts a close-up wireframe view 350 of a rectangular slot 340 for pressurized fluid. In various implementations, the shape of the nozzle with fluid outlet 340 or slot 340 can be circular or rectangular depending on how wide of a fluid pressure profile is needed. In one or more implementations, the nozzles with fluid outlets 340 produce a cone-shaped fluid pressure profile. Varying the nozzle with fluid outlet 340 shape and size correlates with changes in the fluid trajectory shape.

FIG. 3B also displays an internal configuration of hollowed-out portions 344 and 342 of the pressure blaster 310 according to some implementations consistent with the present disclosure. Fluid being passed through the pressure blaster 310 traverses an outer tube 342 before entering into one of a number of short tube segments 344 leading to a nozzle with fluid outlet 340 according to some implementations. The number of short tube segments 344 corresponds to the number of nozzles with fluid outlets 340 in one or more implementations. In implementations where each nozzle with fluid outlet 340 has an opposing external nozzle with fluid outlet for facilitating a zero-thrust outcome, these opposing external nozzles with fluid outlets also have a short internal tube segment 344 leading away from an outer tube ring 342.

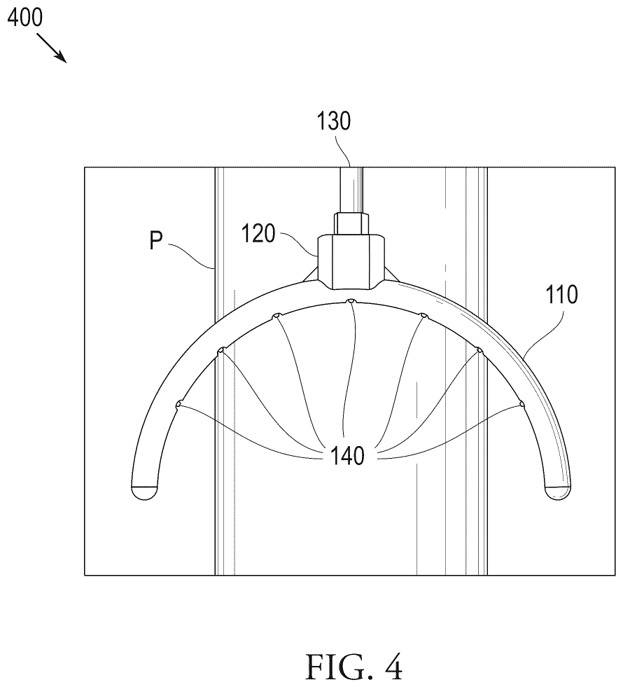

FIG. 4 depicts yet another view 400 of a circular fluid pressure blaster 110 according to one or more embodiments. This half-circle pressure blaster 110 configuration, consistent with some implementations, covers half of a cylindrical pipe or other cylindrical submerged asset. Note that while the figures depicted primarily focus on circular underwater assets, due to their prevalence, other implementations of the present disclosure incorporate pressure blaster fixtures of varying shapes to complement and thereby accommodate different underwater asset shapes, such as squares, rectangles, triangles, or other asymmetrical shapes. This unique benefit of the present disclosure makes the pressure blaster design disclosed herein adaptable for a broad spectrum of underwater asset cleaning.

Another advantage of some implementations of the present disclosure is the possibility for integration with various automation systems. One or more implementations can utilize operators other than human divers. Such operators can include wheeled robots, remotely operated vehicles (ROVs), or other autonomous or semi-autonomous pressure blaster operators. Integration of the pressure blaster designs disclosed herein with automated pressure blaster operators allows for the submerged asset cleaning process to be streamlined and performed without manual intervention. Such integration enhances convenience and also improves overall efficiency by reducing labor requirements and enabling continuous operation. The ability to automate the cleaning process further contributes to increased speed, effectiveness, and precision in maintaining and removing biofouling from underwater assets. Thus, various embodiments and combinatory designs disclosed herein offer the flexibility to cater to different automation mechanisms, making the disclosed pressure blaster design a versatile solution for efficient and automated underwater cleaning. In some variations, the present disclosure further comprises a wheeled mechanism which autonomously moves the base around the underwater structure, and in more particular variations, the wheeled mechanism can include magnets to provide a degree of adherence to the structure being cleaned.

In some implementations, an integrated wheeled mechanism is incorporated and designed to enable the circular pressure blaster 110 to move autonomously or semi-autonomously around underwater structures. In various implementations, this mechanism features a set of wheels attached to the base of the pressure blaster 110, providing the mobility needed to navigate the contours of submerged pipelines and other structures targeted for biofouling removal. In various implementations, a drive system is responsible for the autonomous propulsion of the integrated wheeled mechanism. In one or more implementations, the drive system contains motorized elements required to drive the wheels, allowing the apparatus to advance in a controlled fashion without the need for manual intervention.

In multiple implementations, the wheels, which are affixed to the base of the pressure blaster 110, are the points of contact that facilitate movement across the submerged surfaces. In some variations, the wheels are designed to withstand the underwater environment and provide stable and reliable traversal over the biofouled structures. In multiple implementations, the wheels work in conjunction with the integrated drive system to ensure that the pressure blaster maintains sufficient contact with the structure. The interconnectedness of the integrated wheeled mechanism, the drive system, and the wheels cooperate to facilitate automation of circular pressure blaster 110 movement.

Moreover, in various embodiments, an ultrasonic testing (UT) probe is positioned on the pressure blaster 110. The UT probe accessory variations consistent with the present disclosure enable a diver-operator to conduct an inspection of the target underwater asset while simultaneously performing the biofouling removal and cleaning. This results in valuable efficiency realization and inspection time maximization. Additional implementations of the UT probe coupled to the pressure blaster tool 110 incorporates an additional ring or semi-circle, resulting in two parallel rings or semi-circles. In such implementations, the ring or semi-circle closest to the pipe P contains the pressure nozzles with fluid outlets 140 pointing at the pipe, while the second ring or semi-circle spaced appropriately away from the first has multiple small UT probes in the same arrangement as the nozzles with fluid outlets 140. By incorporating simultaneous cleaning and inspection capabilities for assets, such as ultrasonic testing (UT) and cathodic protection (CP), this implementation variation offers a significant enhancement in efficiency and speed. The integrated design allows for both tasks to be performed concurrently as a single process, eliminating the need for separate operations. In some implementations, the pressure blaster further comprises an ultrasonic test probe positioned to scan the underwater pipe.

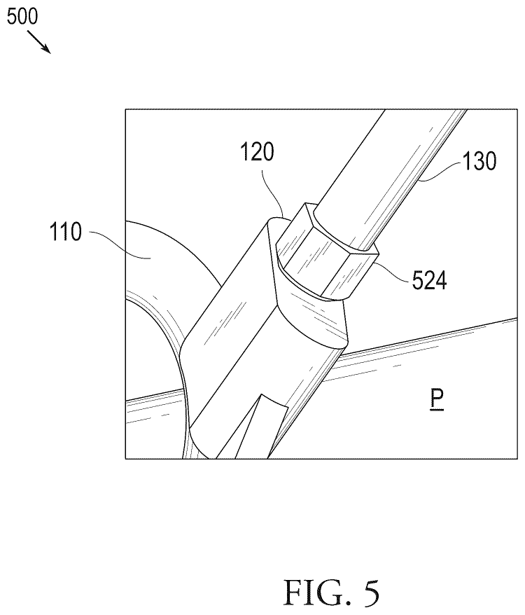

FIG. 5 depicts a universal attachment 120 to connect an implementation comprising an arcuate fluid pressure blaster 110 to a pressure rod 130 according to one or more embodiments. In one or more implementations, the universal attachment 120 for the pressure blaster 110 facilitates the connection of the blaster body to an external pressure rod 130. This attachment 120 ensures the secure and stable integration of the two components. In some implementations, the universal attachment 120 is designed to accommodate variations in the design and size of pressure rods and blasters, making the apparatus adaptable to a range of underwater structures.

In various implementations, the universal attachment 120 features a coupling mechanism 524 that allows for quick and easy connection and disconnection from the pressure rod 130. The coupling mechanism 524 may be magnetic in some implementations. In further implementations, the coupling mechanism 524 incorporates threading. Such a design is advantageous for operations where time underwater is limited, such as those involving divers. By streamlining the process of attachment, the universal connector 120 improves efficiency and utility of the pressure blaster 110 cleaning apparatus.

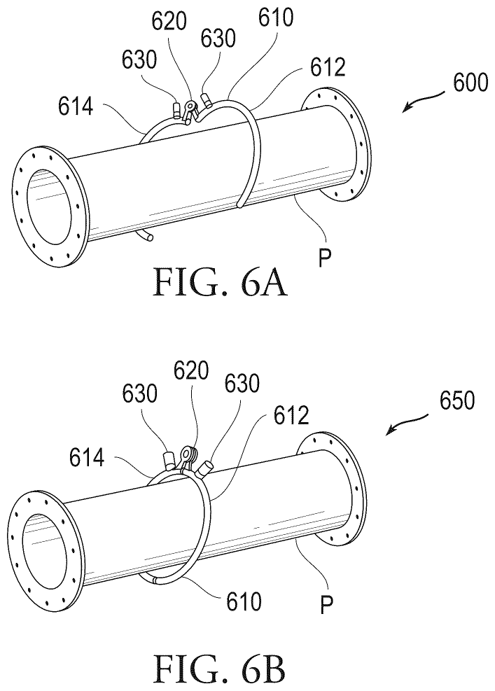

FIG. 6A depicts a fully enclosed pressure blaster 610 apparatus with a hinge 620 in an open configuration 600 according to one or more embodiments. FIG. 6B depicts a fully enclosed pressure blaster 610 apparatus with a hinge 620 in a closed configuration 650 according to one or more embodiments. In some implementations, the fully enclosed pressure blaster apparatus is designed to surround an underwater pipe, using a hinged mechanism 620 that allows the apparatus to open and close around the pipe. In certain implementations, the apparatus consists of two hinged semi-circular arcs (612 and 614) that, when closed, form a substantially if not entirely complete circle around the pipe, ensuring full coverage for cleaning operations. In further implementations, the fully enclosed design streamlines the biofouling removal process by providing consistent pressure around the entire circumference of the pipe in a single operation.

In some implementations, the fully enclosed pressure blaster 610 apparatus includes a Y-connector 620 that links to a high-pressure hose, distributing pressurized fluid evenly to both halves of the apparatus. In various implementations, this configuration allows for simultaneous biofouling removal from all sides of the pipe, improving the efficiency and effectiveness of cleaning. In further implementations, the apparatus' fully circumferential design reduces the need for manual repositioning, saving time and minimizing diver exposure to underwater hazards.

In one or more implementations, the hinged mechanism 620 is equipped with locking features to secure the fully enclosed pressure blaster in a closed position around the pipe, such as in closed position 650. In some implementations, seals or gaskets are incorporated in the locking features to prevent the escape of pressurized fluid and to focus the cleaning action on the pipe's surface. In various implementations, the apparatus is augmented with additional features such as wheels or tracks for autonomous movement along the pipe, ultrasonic test probes for simultaneous inspection, and adjustable nozzle fluid outlet sizes for different cleaning intensities, offering a comprehensive solution for underwater pipe maintenance. In some implementations, the base of the pressure blaster is rotatable to fully encircle the underwater pipe. In some implementations, the base of the pressure blaster includes a hinge mechanism. In some implementations, the pressure blaster further comprises an integrated pressure regulator.

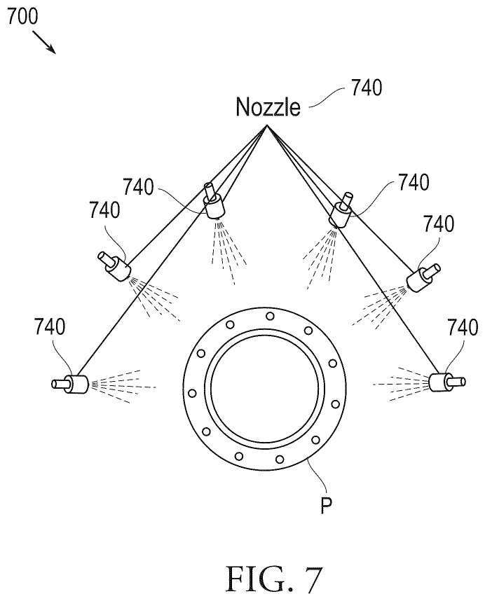

FIG. 7 depicts a multiple nozzle with fluid outlet arrangement 700 for the apparatus according to one or more embodiments. The number of nozzles with fluid outlets in nozzle arrangement 700 is merely exemplary. It is to be understood that there can be more or less nozzles with fluid outlets in a desired pressure blaster nozzle with fluid outlet array consistent with the present disclosure. The nozzles with fluid outlets 740 are arranged around a pipe P. In yet further implementations, the nozzle with fluid outlet arrangement is a continuous slot tracing along the horizontal axis of the pressure blaster fixture, with no gaps in between, allowing the flow of fluid through the slit to be seamless. Such a continuous slot results in the effective area pressure blasting area being a thin line instead of multiple points, which can be advantageous for some applications of blasting away biofouling from pipes or other underwater assets.

In some implementations, instead of having a number of small nozzles with fluid outlets that spray the water towards the target pipe, the continuous slit nozzle fluid outlet variation utilizes a thin slit that spans the whole internal circumference of the mechanism. This wide slit nozzle fluid outlet provides a continuous stream of high-pressure water that cleans the whole circumference of the pipe evenly and at once instead of targeting multiple points around it. This alleviates a limitation with the alternate multi-jet/nozzle concept. In various implementations, the length of the slit is as long as possible to cover the whole circumference of the pipe. However, in such implementations, the width is relatively small to achieve the correct pressure and flow rate for proper cleaning. In further implementations, instead of a uniform slit width across the whole nozzle with fluid outlet, the continuous slit can be made non-uniform with a varying width to maintain equal flow output on the whole circumference of the pipe. Such a variation avoids a problem that results from a uniform slit width, because uniform slit width can lead to a larger flow pressure on the sides of the pressure blaster that are closer to the incoming high-pressure feed while being lower in pressure on the distal sides.

In some implementations, the nozzles with fluid outlets 740 are optimally angled within the pressure blaster attachment. Such nozzle with fluid outlet 740 angle optimization alleviates the need to hold the pressure rod (such as pressure rod 130 in FIG. 1) at an angle. In various implementations of the present disclosure, the pressure blaster contains a mechanism for adjusting the angle of the nozzles with fluid outlets during use. In some implementations, this nozzle with fluid outlet 740 angle adjustment mechanism is used at the site of the underwater asset. In other implementations, this nozzle with fluid outlet 740 angle adjustment mechanism is operated remotely.

Angling the pressure rod or nozzles with fluid outlets relative to the asset to be cleaned is often beneficial for the removal of biofouling. In some implementations, for additional specificity, the angle of the nozzles with fluid outlets should be such that the angle of the fluid spray with respect to the surface, when the tool is held in the target position with respect to the pipe, is approximately 60 degrees off normal of the pipe surface. Such an angle, in some implementations, maximizes the removal of the contaminants.

Furthermore, in some implementations, a local mechanism exists to selectively control which cavitation nozzles with fluid outlets are open. In alternate implementations, open nozzles with fluid outlets are controllable by a remote mechanism such as a user interface hardwired to the pressure blaster. In various implementations, nozzles with fluid outlets 740 further along the circumference of the pressure blaster are of varying sizes or widths based on their distance from a fluid inlet supply. Such a variation in nozzle size ensures that similar levels of fluid pressure are pumped towards a pipe P. In further implementations, a plurality of nozzles with fluid outlets comprises nozzles of varying sizes. In yet further implementations, nozzles are configured to emit a pressurized fluid at an angle. In some implementations, a dimension of an underwater structure to be cleaned by the pressure blaster in a length, width, or radial circumference of the structure. In some implementations, activating the plurality of nozzles comprises maintaining uniform pressure output from nozzles of varying sizes, and the step of maintaining is facilitated by a water pressure gauge

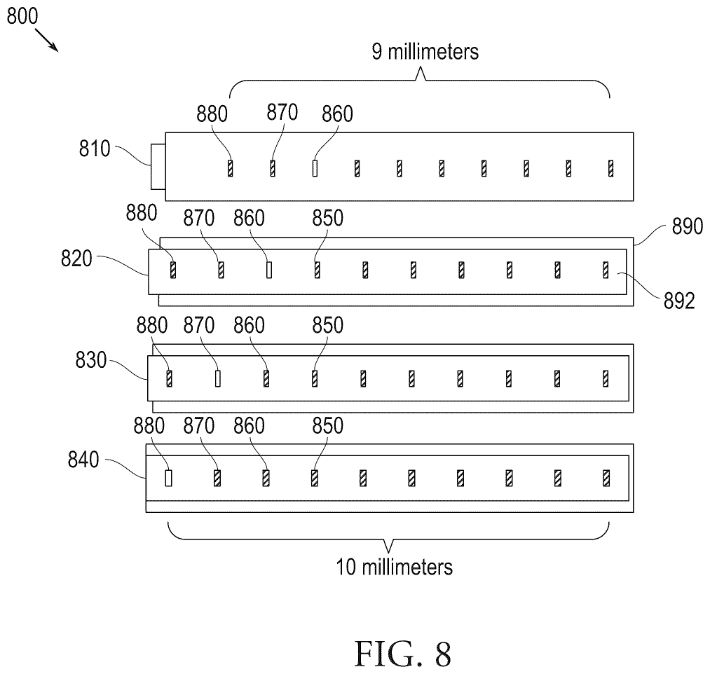

FIG. 8 depicts four exemplary stages of a selectable outlet port mechanism 800 for controlling nozzle fluid pressure and placement according to one or more embodiments. In some implementations, the selectable outlet port mechanism within an underwater fluid pressure blaster such as pressure blaster 110 depicted in FIG. 1 is designed to address the challenge of maintaining effective high-pressure cavitation across multiple outlet ports. In one or more implementations, the sliding mechanism 800 is controlled by shifting a bar patterned with holes to align with the cavitation outlet nozzles such as nozzles 740 in FIG. 7. In further implementations, the sliding mechanism could be designed to allow multiple holes to align with outlet ports simultaneously, providing a more adaptive control over the pressure distribution. In some implementations, the system can be designed with varying hole sizes in the sliding plate to regulate the pressure more precisely, compensating for the pressure variations due to the proximity to the inlet supply.

The basic premise of the selectable outlet port mechanism 800 is that high pressure cavitation is needed to effectively clean the surface of a pipe or underwater asset. Distributing incoming fluid pressure into the fluid blaster's many holes (i.e., nozzles with fluid outlets) requires a higher inlet pressure to achieve sufficient pressure at each opening. Additionally, the holes closer to the inlet typically would receive higher pressure if all of the holes were sized to be the same size, requiring a more complicated outlet nozzle with fluid outlet design. FIG. 8 illustrates an example of a design feature to overcome these limitations where the interior portion of a cavitation device or pressure blaster is modelled as two sliding plates: a back plate 890 and a front plate 892.

In various implementations, the selectable outlet port mechanism includes an internal sliding mechanism—shown in stages 810, 820, 830, and 840—that allows individual outlet ports to be activated or deactivated by opening or closing, thereby ensuring that sufficient selective pressure is maintained at each opening for effective cleaning. The selectable outlet port mechanism 800, as shown in row 810, is an exemplary implementation of a nozzle with fluid outlet 860 selectively being opened. Row 810 shows the back of the device, while rows 820, 830, and 840 show the front progression of the selectable outlet port mechanism moving from right to left. In row 820, the selectable outlet port mechanism 800 depicts nozzle with fluid outlet 860 being opened, according to one or more exemplary implementations. In row 830, selectable outlet port mechanism 800 closes nozzle with fluid outlet 860 and opens nozzle with fluid outlet 870. In row 840, selectable outlet port mechanism 800 closes nozzle with fluid outlet 870 and opens nozzle with fluid outlet 880. This progression of opening and closing nozzles is one of a number of ways to selectively open and close pressure blaster nozzles according to one or more embodiments of the present disclosure.

The cavitation outlets can be various shapes in alternate implementations, and they are depicted as rectangular openings in FIG. 8. In FIG. 8, 10 openings spaced equidistantly from one another are shown, as consistent with one or more implementations. An exemplary spatial distance between the first and last hole is 10 millimetres. The back plate 890 (which is the thicker portion behind the front plate 892) can, for example, have matching holes equally spaced apart, spanning a total of 9 millimetres. With such a configuration, when the back bar 890 slides sideways by 1 millimetre, the next set of holes aligns, and thus by moving the internal sliding mechanism through a range of 10 mm, each of the 10 holes in front bar 892 can be individually activated.

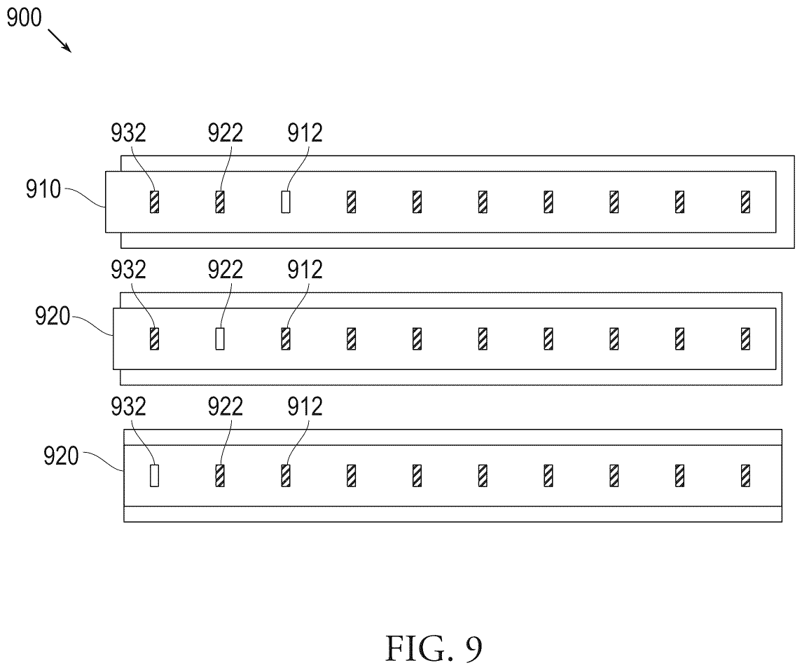

FIG. 9 depicts a wireframe view of a selectable outlet port mechanism for controlling nozzle fluid pressure and placement according to one or more embodiments. The line drawing of FIG. 9 shows the three lower sets from FIG. 8 (rows 820, 830, and 840) with the selectable outlet port mechanism's back-plate's holes dotted to show their location behind a front bar of the selectable outlet port mechanism. In various implementations, the selectable outlet port mechanism includes an internal sliding mechanism—shown again in the progressive stages 910, 920, and 930—that allows individual outlet ports—such as 912, 922, and 932—to be activated or deactivated by opening or closing, thereby ensuring that sufficient selective pressure is maintained at each opening for effective cleaning. The selectable outlet port mechanism 900, as shown in row 910, is an exemplary implementation of a nozzle with fluid outlet 912 selectively being opened. The selectable outlet port mechanism 900 then proceeds to row 920, where the nozzle with fluid outlet 912 is closed and nozzle with fluid outlet 922 is opened, according to one or more exemplary implementations. In row 930, selectable outlet port mechanism 900 closes nozzle with fluid outlet 922 and opens nozzle with fluid outlet 932. This progression of opening and closing nozzles is one of a number of ways to selectively open and close pressure blaster nozzles with fluid outlets according to one or more embodiments of the present disclosure.

In alternative implementations of the selectable outlet port mechanism 900, the mechanism has two or more holes aligned at once. In some implementations, the selectable outlet port mechanism 900 has larger holes in the sliding plate such that adjacent holes stay open through multiple locations. In yet more implementations, the selectable outlet port mechanism 900 has an outer plate that has larger or longer holes such that the interior holes are aligned with the larger openings through a larger range of motion. Such implementations ensure that fluid pressure is more evenly dispersed within the aligned holes along the length of the cavitation pressure blaster.

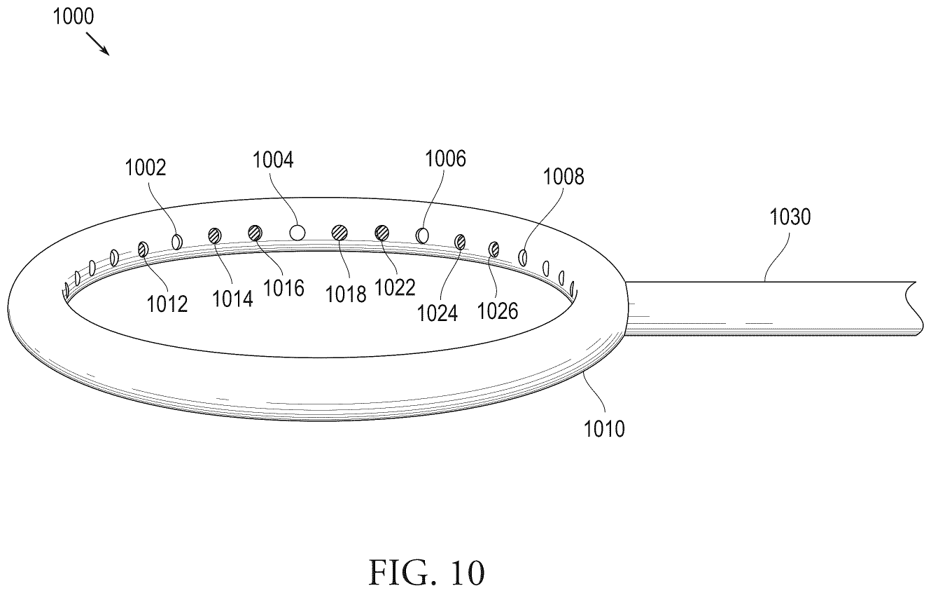

FIG. 10 depicts a three-dimensional perspective view of a fully circular design incorporating a selectable outlet port mechanism 1000 for controlling nozzle fluid pressure and placement according to one or more embodiments. Pressure rod 1030 is analogous to pressure rod 130 depicted in FIG. 1. Pressure rod 1030 also represents the inlet supply of fluid to be forced through nozzles with fluid outlets 1002 through 1026, according to one or more implementations. FIG. 10 depicts the basic premise of the alignment of the holes and nozzles with fluid outlets around the pressure blaster ring 1010, according to one or more exemplary implementations. In some implementations, there is a hole present every 10 degrees within the internal circumference of the pressure blaster ring 1010. In some implementations, sliding plates within the pressure blaster ring 1010 are spaced apart by every 15 degrees within the inner circumference of the pressure blaster ring 1010. In exemplary implementations where the ring holes are spaced every 10 degrees and the sliding plates every 15 degrees, alignment occurs at every third hole in the cavitation blaster shell by a 5-degree rotation in either direction. This ensures a different set of holes open such that with variation in three different positions any three sets of holes can be opened for cavitation.

In various implementations, the actuation of the sliding mechanism is designed to be versatile, accommodating different methods of operation, including mechanical and electronic controls. In some implementations, the actuation can be achieved through a rack and pinion system, or by using a flexible and spring-loaded bar that can be incrementally positioned. In further implementations, adjustments to the system could be made from the surface or a remote location, allowing divers or operators to modify the pressure blaster settings without direct physical interaction. These designs enhance the functionality and user-friendliness of the pressure blaster, making it adaptable to various underwater maintenance tasks.

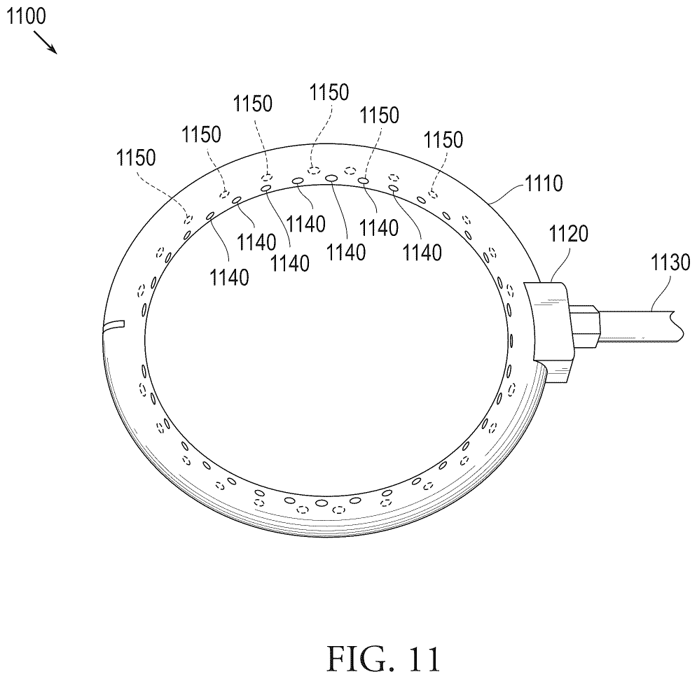

FIG. 11 depicts a wireframe view of a three-dimensional perspective rendering 1100 of a fully circular design incorporating a selectable outlet port mechanism for controlling nozzle fluid pressure and placement according to one or more embodiments. In some implementations, such an arrangement includes a universal attachment 1120, analogous to universal attachment 120 in FIG. 1. In some implementations, such an arrangement includes a pressure rod 1130, analogous to pressure rod 130 in FIG. 1. This wireframe view clarifies the difference in degree of spacing between internal pressure blaster holes 1140 and internal sliding plate holes 1150, such that alignment occurs at every third hole in the cavitation blaster shell with a minor degree of rotation—such as 5-degree rotation—in either direction.

Different implementations of the present disclosure can be configured to employ different means for actuation of the selectable outlet port mechanism depicted in FIGS. 8-11. In some implementations, the bottom edge of the inner ring has teeth and rotates in a rack and pinion setup via an actuator. In yet further implementations, the bottom edge of the inner ring has teeth and rotates in a rack and pinion setup by manual pulling of a mechanism that rotates the pinion. In some implementations, the inner section is a flexible bar, such as spring steel with approximately 1 mm thickness, and fits in a slot. In such implementations, cavitation holes are drilled into a flattened surface that matches this sliding spring steel element on the interior of the ring. In some implementations, the steel element is spring-loaded to move into an initial position.

In some implementations, the spring steel is subsequently pulled incrementally to shift into alternate positions. In various implementations, the pulling mechanism can be a handle with a wire if used by a diver, or it could be a servo motor or another type of mechanism to move the spring steel element's position along the interior wall of the ring. It is to be understood that various other mechanisms can be used for actuating the interior ring within the exterior pressure blaster ring. In some implementations, the mechanism for actuating the interior ring is a rack and pinion. In various implementations, the mechanism for actuating the interior ring is a worm gear and a screw. In some implementations, the mechanism for actuating the interior ring is a hydraulically actuated pressure engagement system. In some implementations, the mechanism for actuating the interior ring is a magnet system that rotates the inner ring using magnetic forces

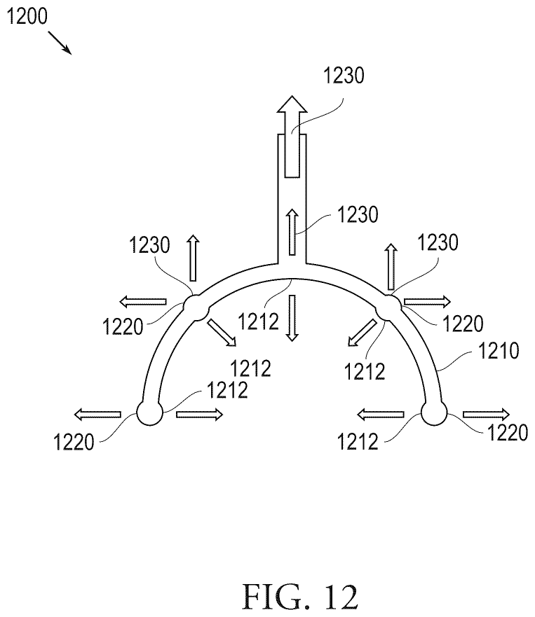

FIG. 12 depicts a half-circle nozzle with fluid outlet configuration 1200 where jets 1212 point towards an underwater asset, with arrows pointing inward to represent fluid flow, according to one or more embodiments. Forces 1220 and 1230 are resulting vertical and horizontal forces, respectively, resulting from the fluid flow out of the jets 1212. Additional nozzles with fluid outlets are included opposite the jets 1212, in various implementations, for counteracting the undesirable fluid flow forces 1220 and 1230. The vertical and horizontal opposing forces 1220 and 1230 reactively impact a pressure blaster system underwater, and, in some implementations, jets positioned opposite the nozzles with fluid outlets 1212 counteract those forces so the pressure blaster remains in a desired position relative to an underwater asset to be cleaned.

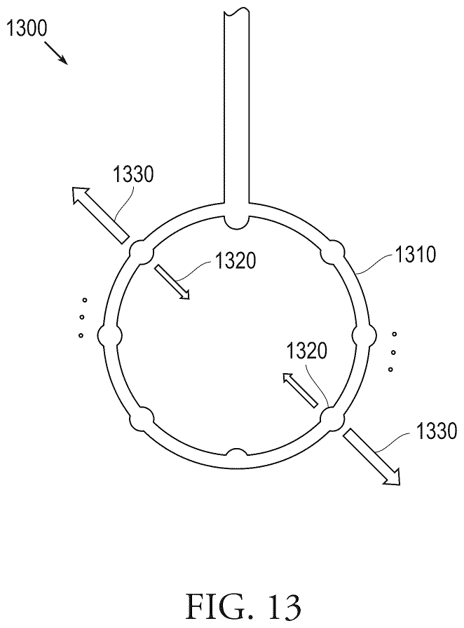

FIG. 13 depicts a full-circle nozzle with fluid outlet configuration 1300 where, again, each nozzle with fluid outlet 1320 has an equal and opposite nozzle with fluid outlet for counteracting fluid flow force 1330, according to one or more embodiments. In such full-circle configurations, nozzles opposite each will be opened simultaneously to counteract the reactive fluid flow force 1330, thus keeping the pressure blaster 1310 in its desired position relative to an underwater asset. The present disclosure uniquely solves the problem of prior solutions failing to withstand high-pressure applications for cavitation blasting to remove biofouling. Additional implementations include a mathematically optimized pressure regulator system for enabling varied pressure to be pumped from each nozzle with fluid outlet of a cavitation blaster.

Preexisting cavitation pumps and pressure blasters typically have one outlet at the front for cleaning and another at the back to balance forces. One or more embodiments consistent with the present disclosure incorporate the concept of using many outlets for cleaning. This is likely to result in pressure imbalances between those outlets (i.e., nozzles, nozzles with fluid outlets, ports, or holes) closer to the inlet line (for example, through pressure rod 130 in FIG. 1) compared to those outlets (i.e., nozzles, nozzles with fluid outlets, ports, or holes) further from the inlet. In order to compensate for this, one or more implementations of the present disclosure include different hole sizes optimized using computational fluid dynamics simulations to create balanced jets (considering flow and pressure) across the series of holes regardless of their distance from the inlet source, which is in communication with the plurality of nozzles. Such design implementations contribute to balanced fluid jet streams pumped from the pressure blasters. Multiple implementations include nozzle with fluid outlet pairs facing and opposing the underwater asset to be cleaned. Some implementations incorporate an activation mechanism to begin pumping fluid through the pressure blaster. In some implementations, the activation mechanism is a switch.

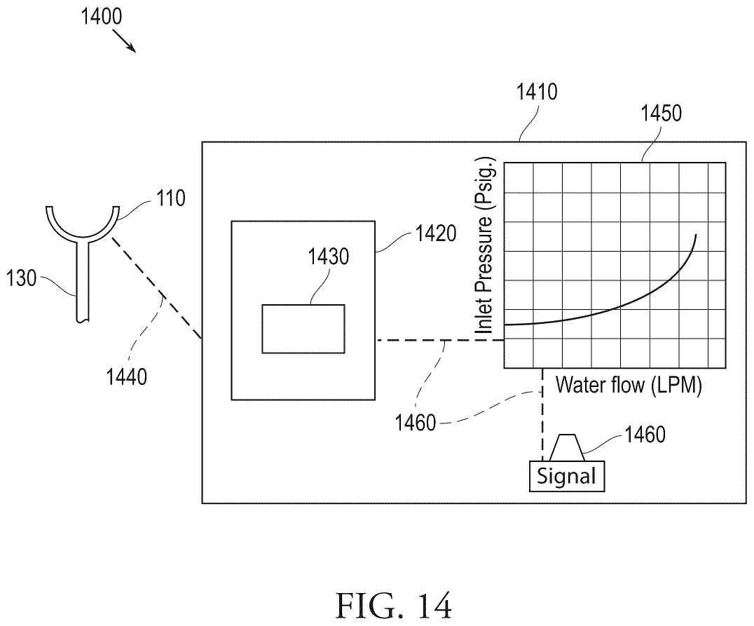

FIG. 14 depicts a block diagram 1400 of a control system 1410 acting as an internal pressure regulator for the pressure blaster 110, according to one or more embodiments. In some implementations, a control system 1410 of the apparatus operates as a central command center, overseeing the dynamic operation of the circular pressure blaster 110—such as the pressure blaster 110 in FIG. 1—and the integrated pressure regulator. This control system coordinates precise delivery of pressurized fluid through the various nozzles—such as the nozzles having fluid pressure valves 140 in FIG. 2—for executing the biofouling removal process. In various implementations, the integrated pressure regulator includes a pressure graphical user interface (GUI) 1450 depicting fluctuations in inlet pressure against fluid flow out of the pressure blaster 110.

In various implementations, a processor 1420 with a memory 1430 exists within the control system 1410 of the pressure regulator 1450. In some implementations, this processor 1420 executes instructions from the memory and processes data communicated to and from the pressure blaster 110. In one or more implementations, the processor 1420 is configured by code from the memory to modify and manage system operations, making real-time adjustments to the pressure blaster 110 cleaning mechanisms as necessary. In one or more implementations, the memory 1430 component of the control system 1410 serves as the repository for the operational code and data needed by the processor. It allows for the retrieval and storage of information, responding to process variability during the execution cleaning tasks.

In some implementations, code stored in the memory is comprised of a sequence of instructions that the processor 1420 utilizes to control the operations of the circular pressure blaster 110. This code instructs the processor 1420 on when to initiate or halt fluid delivery, adjust pressures, and respond to data from the integrated pressure regulator, such as data depicted in the pressure GUI 1450, to enable modulation of the function of the nozzles with fluid pressure valves 140. In multiple implementations, the control system 1410 is in electronic communication 1440 with the pressure blaster 110. Similarly, the components of the control system 1410 are in electronic communication 1460 with each other.

In various implementations, an output signal is emitted from the integrated pressure regulator 1450. In some implementations, this output signal 1460 is a feedback mechanism that informs the control system 1410 about the pressure levels within the blaster 110. In some variations, this signal enables the control system 1410 to make adjustments in real-time, ensuring that each nozzle operates within the optimal pressure range to remove biofouling effectively without damaging the underwater structure. In one or more implementations, the synchronization of the processor 1420 with this output signal facilitates maintenance of equilibrium of forces during cleaning, characterized by the zero-thrust configuration of the nozzles 140.

In various implementations that incorporate a full-circle pressure blaster design such as that depicted in FIGS. 6A, 6B, 10, 11, and 13, high-pressure use cases benefit from the closed-circle design feature through latching the two half-circle arcs together, for example, magnetically or mechanically. In some implementations, the magnetic or mechanical latches (or a combination of the two) exist at the ends of the arcs where they touch to form a circle. Such implementations are suitable when the biofouled structure to be cleaned has a circular configuration, such as a pipe. More generally, portions of a pressure blaster can be latched together with other exterior shapes to complement the exterior surface of the structure to be cleaned.

In other implementations, the magnetic or mechanical latches (or a combination of the two) exist at the base of the joint, such as joint 620 depicted in FIG. 6A. In various implementations, the magnetic or mechanical latches (or a combination of the two) exist in both the base of the ends of the arcs and the base of the joint. One non-limiting example of a mechanical latching system is a pin—such a pin would prevent the joint from opening once set in place.

It is to be understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. An apparatus for removing biofouling from an underwater structure, comprising:
a base,
wherein the base defines a predetermined shape having a surface therealong;
a plurality of nozzles,
wherein the plurality of nozzles are arranged in a line along the surface of the base, and
wherein at least one of the nozzles is directed towards the underwater structure;
an inlet supply, and
wherein the inlet supply is in communication with the plurality of nozzles, and
wherein the inlet supply provides pressurized fluid to the nozzles; and
a zero-thrust nozzle which is positioned and which has a fluid outlet which is sized to balance forces exerted by the pressurized fluid directed towards the underwater structure by the at least one of the plurality of nozzles so as to maintain a spacing of the apparatus relative to the underwater structure within a prescribed tolerance.

2. The apparatus of claim 1, wherein the plurality of nozzles include respective valves that are selectively operable to open and close.

3. The apparatus of claim 1, wherein an arrangement of the nozzles forms a continuous slit along the surface of the base.

4. The apparatus of claim 1, further comprising a drive system and wheels connected to the base, wherein the drive system autonomously moves the wheels and the base around the underwater structure.

5. The apparatus of claim 1, wherein the plurality of nozzles comprises at least two nozzles of different size.

6. The apparatus of claim 1, wherein the nozzles are configured to emit a pressurized fluid at an angle relative to the base.

7. The apparatus of claim 1, further comprising an ultrasonic test probe positioned to scan the underwater structure.

8. The apparatus of claim 1, wherein the base is rotatable to fully encircle the underwater structure.

9. The apparatus of claim 1, wherein at least a portion of the base comprises first and second arcuate segments, further comprising a hinge mechanism connecting the first arcuate segment of the base with the second arcuate segment of the base.

10. The apparatus of claim 1, wherein the base further comprises:
a control system having a processor, a memory, and code stored in the memory and executable in the processor; and
an integrated pressure regulator having an output signal,
wherein the processor is configured by the code to modify the pressure output by the plurality of nozzles in response to the output signal from the integrated pressure regulator.

11. The apparatus of claim 1, wherein the predetermined shape of the base complements the shape of the underwater structure.

12. A method of removing biofouling from an underwater structure, comprising:
positioning a fluid blaster having a predetermined shape in proximity to an underwater structure;
activating a plurality of nozzles on the fluid blaster,
wherein the step of activating is performed by an activation mechanism,
and wherein the fluid blaster emits a stream of pressurized fluid towards the underwater structure once activated; and
moving the fluid blaster along a dimension of the underwater structure.

13. The method of claim 12, further comprising selectively operating individual nozzles which include respective valves.

14. The method of claim 12, wherein activating the plurality of nozzles comprises creating a continuous pressurized stream from a perforation arrangement.

15. The method of claim 12, further comprising automating the movement of the fluid blaster using an integrated wheeled mechanism, wherein the integrated wheeled mechanism advances the wheels and the base around the underwater structure, and wherein the step of advancing is performed by a drive system.

16. The method of claim 12, wherein activating the plurality of nozzles comprises maintaining uniform pressure output from at least two nozzles of different size, and wherein the step of maintaining is facilitated by a water pressure gauge.

17. The method of claim 12, further comprising adjusting the angle of the pressurized fluid emission relative to the underwater structure.

18. The method of claim 12, further comprising inspecting the structure using an integrated ultrasonic test probe.

19. The method of claim 12, further comprising adjusting the fluid blaster angle relative to the structure.

20. The method of claim 12, further comprising adjusting the pressure output for individual nozzles.

21. The method of claim 20, wherein the step of adjusting the pressure output is performed with an integrated pressure regulator;
wherein the integrated pressure regulator has a control system having a processor, a memory, and code stored in the memory and executable in the processor;
wherein the integrated pressure regulator has an output signal; and
wherein the processor is configured by the code to modify the pressure output by the plurality of nozzles in response to the output signal from the integrated pressure regulator.

22. The method of claim 12, wherein the predetermined shape of the fluid blaster complements the shape of the underwater structure.
